(19) United States
(12) Patent Application Publication
(10) Pub. No.: US 2019/0088970 A1
(43) Pub. Date: Mar. 21, 2019

(54) SOLID OXIDE FUEL CELLS WITH THICKNESS GRADED ELECTROLYTE

(71) Applicant: PHILLIPS 66 COMPANY, Houston, TX (US)

(72) Inventors: Ying Liu, Bartlesville, OK (US); Mingfei Liu, Bartlesville, OK (US)

(73) Assignee: PHILLIPS 66 COMPANY, Houston, TX (US)

(21) Appl. No.: 16/135,498

(22) Filed: Sep. 19, 2018

Related U.S. Application Data
(60) Provisional application No. 62/560,355, filed on Sep. 19, 2017.

(51) Int. Cl. H01M 8/1253; H01M 4/90

(52) U.S. Cl. CPC H01M 8/1253; H01M 2008/1293; H01M 4/9033

(57) ABSTRACT

A solid oxide fuel cell comprising a variable thickness electrolyte layer in contact between an anode and a cathode. The solid oxide fuel cell also comprises a fuel inlet and a fuel outlet. In the solid oxide fuel cell, the variable thickness electrolyte layer is thinner closer to the fuel inlet and thicker closer to the fuel outlet.

### CROSS-REFERENCE TO RELATED APPLICATIONS

This application is a non-provisional application which claims the benefit of and priority to U.S. Provisional Application Ser. No. 62/560,355 filed Sep. 19, 2017, entitled “Solid Oxide Fuel Cells with Thickness Graded Electrolyte”, which is hereby incorporated by reference in its entirety.

### STATEMENT REGARDING FEDERALLY SPONSORED RESEARCH OR DEVELOPMENT

None.

### FIELD OF THE INVENTION

This invention relates to a method for producing solid oxide fuel cells with thickness graded electrolyte.

### BACKGROUND OF THE INVENTION

A solid oxide fuel cell (SOFC) system can be subjected to various interruptions that can prevent electricity from being generated from the SOFC system. One known problem is the unevenness of temperature across a SOFC when in operation.

SOFCs typically consist of three ceramic components, a dense electrolyte and two porous electrodes. Oxygen is reduced to oxygen ions in the cathode and the oxygen ions are transported through the thin electrolyte and react with fuel in the anode to generate water vapor and/or carbon dioxide. Electrons released at the anode flow through the external circuit and produce electricity. Performance of SOFC's is governed by ohmic resistance of the electrolyte and the polarization resistance of electrodes.

The operation of these SOFC's causes significant temperature gradients to exist due to various causes such as cooling effect from feeding gases, fuel utilization variation in different cell regions, the endothermic internal reforming of hydrocarbon fuels, and convection cooling around cell outer perimeters. In some SOFCs the temperature gradient can be as much as 150° C. Excessive temperature gradients will affect fuel cell efficiency since each fuel cell material is best suited for a particular temperature range. In addition, large temperature gradients can result in high levels of thermal stress which can impair durability and reliability of the cells and stacks.

There exists a need for a SOFC that can maintain an even temperature across the electrolyte surface during operation.

### BRIEF SUMMARY OF THE DISCLOSURE

A solid oxide fuel cell comprising a variable thickness electrolyte layer in contact between an anode and a cathode. The solid oxide fuel cell also comprises a fuel inlet and a fuel outlet. In the solid oxide fuel cell, the variable thickness electrolyte layer is thinner n areas closer to the fuel inlet and thicker closer to the fuel outlet. A planar solid oxide fuel cell comprising an yttria-stabilized zirconia variable thickness electrolyte layer in contact between an anode, comprising nickel oxide and yttria-stabilized zirconia, and a cathode comprising lanthanum strontium cobalt ferrite and gadolinium doped ceria. The solid oxide fuel cell also comprises a fuel inlet and a fuel outlet. In this embodiment, the yttria-stabilized zirconia variable thickness electrolyte layer in areas closer to the fuel inlet of natural gas is thinner than in areas closer to the fuel outlet of natural gas. Additionally, the difference between the thickest area of the yttria-stabilized zirconia variable thickness electrolyte layer and the thinnest area of the yttria-stabilized zirconia variable thickness electrolyte layer is greater than about 2.0 μm.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a conventional planar SOFC stack.

FIG. 2 depicts a conventional tubular SOFC.

FIG. 3 depicts a crosscut of a planar SOFC with a variable thickness electrolyte layer.

FIG. 4 depicts a crosscut of a tubular SOFC with a variable thickness electrolyte layer.

FIG. 5 depicts the placement of the thermocouples on an SOFC 102.

FIG. 6 depicts a comparative temperature results obtained at operating the SOFC to output 200 mA/cm².

FIG. 7 depicts a comparative temperature results obtained at operating the SOFC to output 400 mA/cm².

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The following examples of certain embodiments of the invention are given. Each example is provided by way of explanation of the invention, one of many embodiments of the invention, and the following examples should not be read to limit, or define, the scope of the invention.

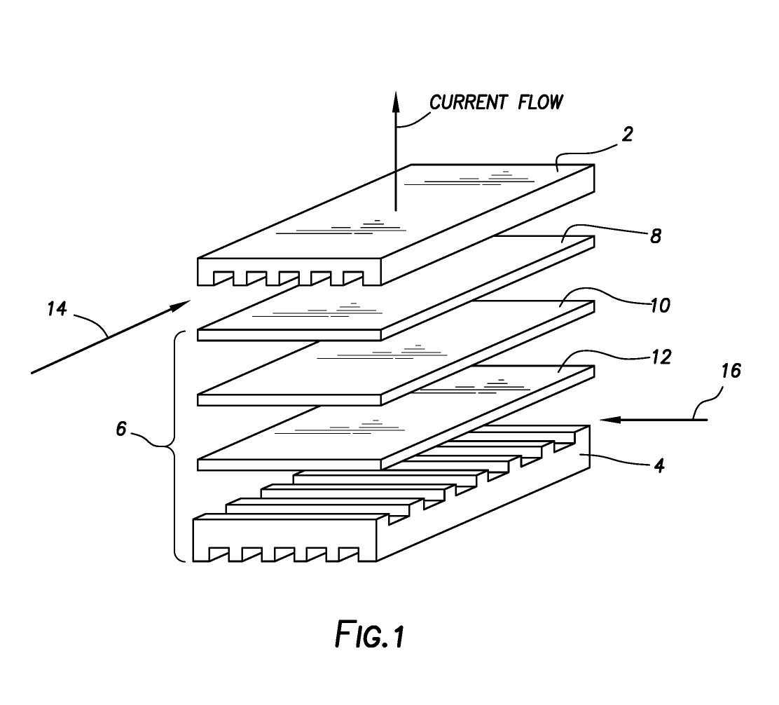

FIG. 1 depicts the repeat unit of a conventional planar SOFC stack. As depicted in FIG. 1, the repeat unit of a conventional planar SOFC stack has a top interconnect (2) and a bottom interconnect (4). In between the top interconnect and the bottom interconnect comprises multiple fuel cell components (6). Only one fuel cell is depicted in FIG. 1. The fuel cell comprises an anode (8) that is above an electrolyte (10) that is above a cathode (12). As shown in FIG. 1, the direction of fuel flow (14) is shown to be perpendicular to the air flow (16). The unlabeled channels parallel to the air flow in the top interconnect and the bottom interconnect are used to channel air through the SOFC stack. The unlabeled channels parallel to fuel flows in the top interconnect and the bottom interconnects are used to channel fuel through the SOFC stack.

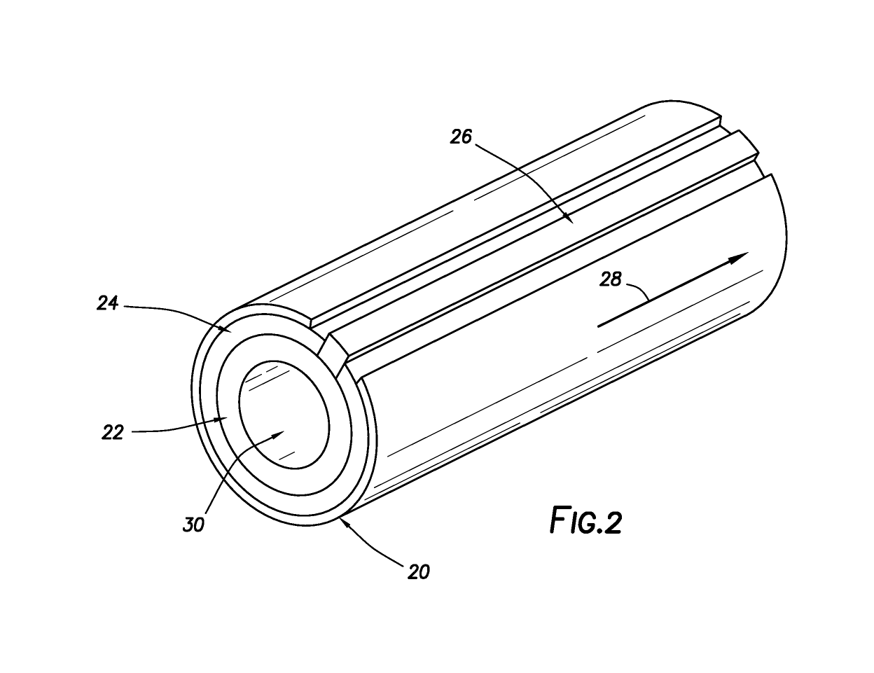

FIG. 2 depicts a conventional tubular SOFC. As depicted in FIG. 2, a conventional tubular SOFC has an outer anode (20) and an inner cathode (22). In between the anode and the cathode is the electrolyte (24). An interconnect (26) is placed within the conventional tubular SOFC. As depicted in FIG. 2, the direction of the fuel flow (28) and the air flow (30) are in the same direction. In conventional tubular SOFCs the fuel flows on the outside of the tubular SOFC while air flows inside the tubular SOFC, or vice versa.

During the operation of a SOFC fuel enters from one side (fuel inlet) and exits from the other side (fuel outlet). In different embodiments of the novel SOFC it is envisioned that the electrolyte layer will be thinner closer to the fuel inlet of fuel flow and thicker closer to the fuel outlet of fuel flow. In an alternate embodiment it is envisioned that the electrolyte layer will be thicker closer to the fuel inlet of fuel flow and thinner closer to the fuel outlet of fuel flow.

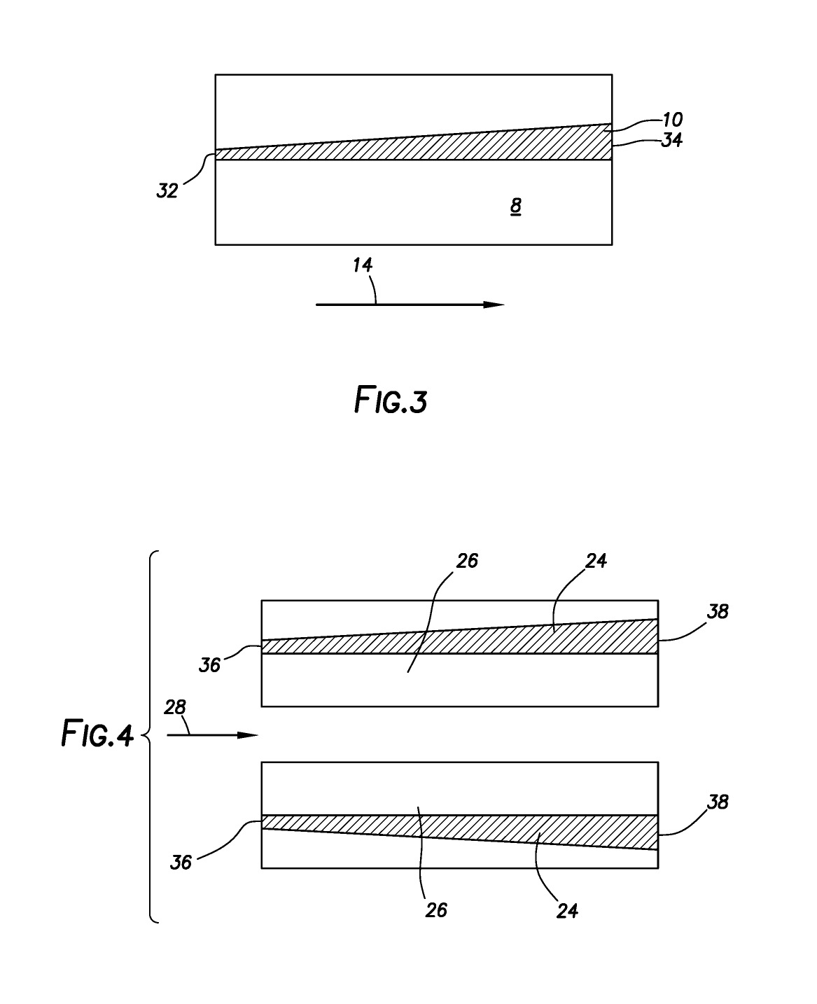

FIG. 3 depicts a crosscut of a planar SOFC wherein the variable thickness electrolyte layer is thinner closer to the fuel inlet and thicker closer to the fuel outlet, in this embodiment the fuel stream (14) flows across the anode (8) that is connected to variable thickness electrolyte (10). As shown, the fuel inlet side (32) of the variable thickness electrolyte is thinner than the fuel outlet side (34).

FIG. 4 depicts a crosscut of a tubular SOFC wherein the variable thickness electrolyte layer is thinner closer to the fuel inlet and thicker closer to the fuel outlet, in this embodiment the fuel flow (28) flows across the anode (26) that is connected to the variable thickness electrolyte (24). As shown, the fuel inlet side (36) of the electrolyte is thinner than the fuel outlet side (38).

In one embodiment, the difference between the thickest area of the variable thickness electrolyte layer and the thinnest area of the variable thickness electrolyte layer is greater than about 50 μm, in other embodiments it is greater than 2 μm, 10 μm even 30 μm. In another embodiment, the difference between the thickest area of the variable thickness electrolyte layer and the thinnest area of the variable thickness electrolyte layer is from about 1 μm to about 50 μm. In yet another embodiment, wherein the difference between the thickest area of the variable thickness electrolyte layer and the thinnest area of the variable thickness electrolyte layer is from about 5 μm to about 10 μm.

In one embodiment, variable thickness electrolyte materials for the SOFC can be any conventionally known electrolyte materials. One example of electrolyte materials can include doped zirconia electrolyte materials, doped ceria materials or doped lanthanum gallate materials. Examples of dopants for the doped zirconia electrolyte materials can include: CaO, MgO, Y₂O₃, Sc₂O₃, Sm₂O₃ and Yb₂O₃. In one embodiment the variable thickness electrolyte material is a yttria-stabilized zirconia, (ZrO₂)_{0.92}(Y₂O₃)_{0.08}.

In one embodiment, anode materials for the SOFC can be any conventionally known anode materials. Examples of the anode materials can include mixtures of NiO, yttria-stabilized zirconia, CuO, CoO, and FeO. In one embodiment the anode material is a mixture of 50 wt % NiO and 50 wt % yttria-stabilized zirconia. In another embodiment the anode material is a mixture of a nickel oxide and a gadolinium doped ceria.

In one embodiment, cathode materials for the SOFC can be any conventionally known cathode materials. One example of cathode materials can be perovskite-type oxides with the general formula ABO₃, wherein A cations can be La, Sr, Ca, Pb, etc. and B cations can be Ti, Cr, Ni, Fe, Co, Zr, etc. Other examples of cathode materials can be mixtures of electronic conductors such as lanthanum strontium cobalt ferrite, lanthanum strontium manganite and ionic conductors such as yttria-stabilized zirconia, gadolinium doped ceria. Examples of the cathode materials include: La_{0.6}Sr_{0.4}CoO_{3-δ}; Pr_{0.5}Sr_{0.5}FeO_{3-δ}; Sr_{0.9}Ce_{0.1}Fe_{0.8}Ni_{0.2}O_{3-δ}; Sr_{0.8}Ce_{0.1}Fe_{0.7}Co_{0.3}O_{3-δ}; LaNi_{0.6}Fe_{0.4}O_{3-δ}; Pr_{0.8}Sr_{0.2}Co_{0.2}Fe_{0.8}O_{3-δ}; Pr_{0.7}Sr_{0.3}Co_{0.2}Mn_{0.8}O_{3-δ}; Pr_{0.8}Sr_{0.2}FeO_{3-δ}; Pr_{0.6}Sr_{0.4}Co_{0.8}Fe_{0.2}O_{3-δ}; Pr_{0.4}Sr_{0.6}Co_{0.8}Fe_{0.2}O_{3-δ}; Pr_{0.7}Sr_{0.3}Co_{0.9}Cu_{0.1}O_{3-δ}; Ba_{0.5}Sr_{0.5}Co_{0.8}Fe_{0.2}O_{3-δ}; Sm_{0.5}Sr_{0.5}CoO_{3-δ}; Pr₂NiO_{4+δ}; and LaNi_{0.6}Fe_{0.4}O_{3-δ}. In one embodiment the cathode material is a mixture of gadolinium-doped ceria (Ce_{0.9}Gd_{0.1}O₂) and lanthanum strontium cobalt ferrite (La_{0.6}Sr_{0.4}Co_{0.2}Fe_{0.8}O₃) or a mixture of gadolinium-doped ceria (Ce_{0.9}Gd_{0.1}O₂) and samarium strontium cobaltite, Sm_{0.5}Sr_{0.5}CoO₃.

In one embodiment, the formation of the variable thickness electrolyte layer is formed on an anode support using a spray coating process. Formation of the electrolyte slurry can be made by mixing suitable materials for forming the electrolyte powder with solvents, dispersants, binders and plasticizers to form a stable slurry. The resulting slurry is then applied on top of an anode substrate to form a continuous electrolyte layer using a spray nozzle. Variation in electrolyte thickness can be achieved either by adjusting flow rate of electrolyte slurry or by changing the number of spray passes. The number of passes can range from about 2 to about 50. Other methods for varying electrolyte thickness may include tape casting and lamination, dry pressing with specially designed pressing heads, and thermal spraying such as plasma spraying and high velocity oxy-fuel spraying.

### EXAMPLE 1

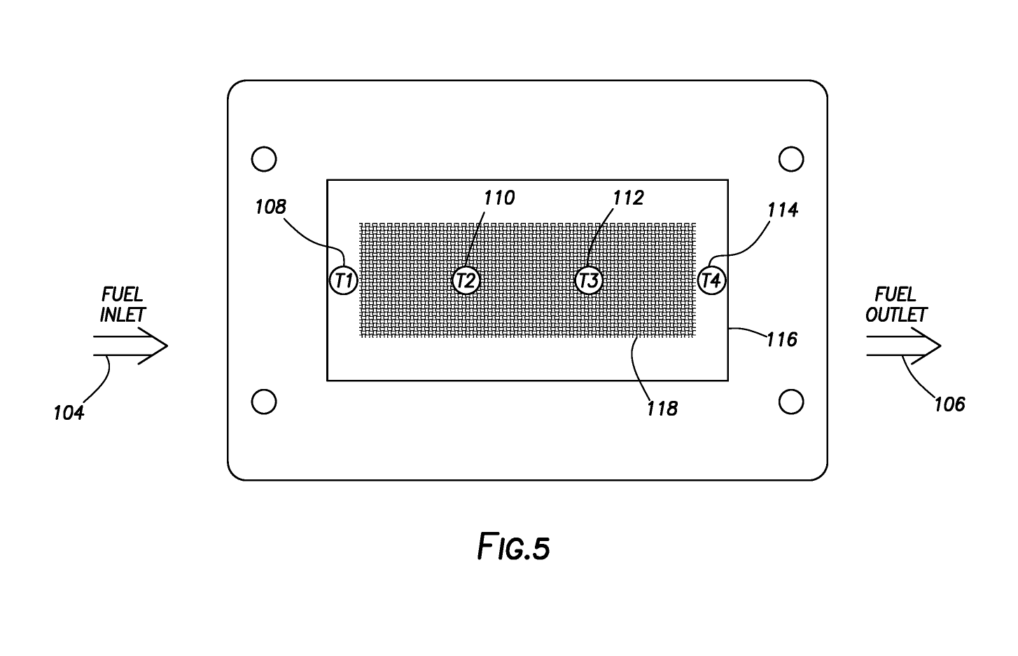

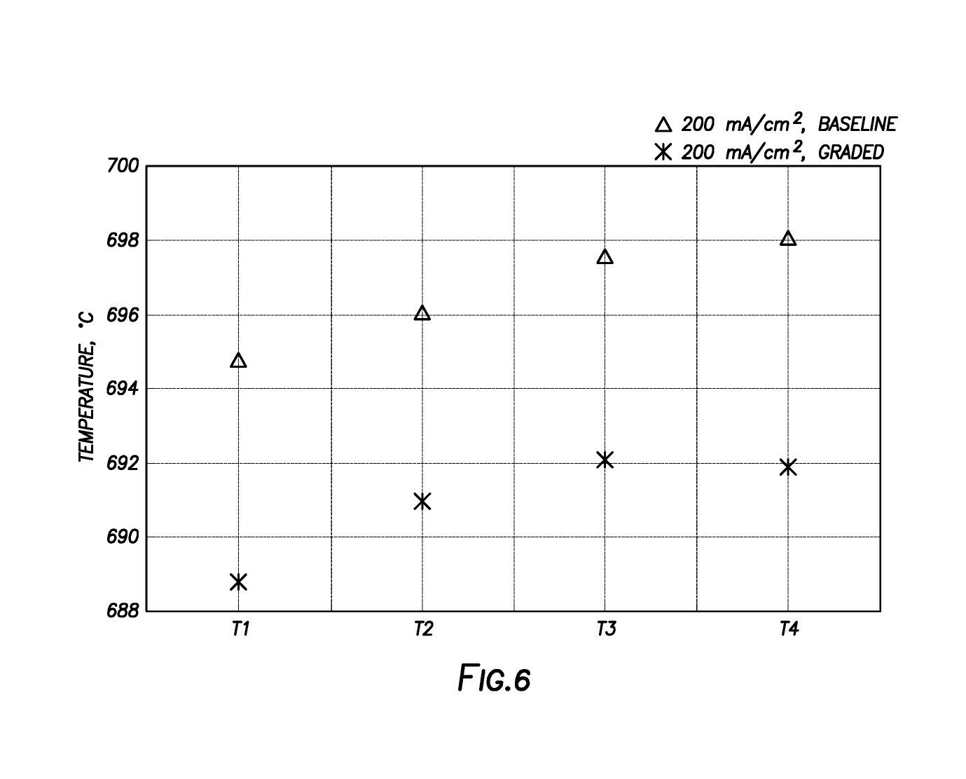

An SOFC with a variable thickness electrolyte was made. Four thermocouples were placed along the SOFC along the variable thickness electrolyte layer. Thermocouple 1 (T1) was placed in an area wherein the electrolyte layer was 3-4 μm thick, thermocouple 2 (T2) was placed in an area wherein the electrolyte layer was 4-5 μm thick, thermocouple 3 (T3) was placed in an area wherein the electrolyte layer was 5-6 μm thick, and thermocouple 4 (T4) was placed in an area wherein the electrolyte layer was 7-8 μm thick. FIG. 5 depicts the placement of the thermocouples on an SOFC 102. This particular embodiment of the SOFC has four unmarked holes as alignment holes for the SOFC. The fuel inlet side of the SOFC is on 104 with the fuel outlet on 106. Thermocouples 108, 110, 112, 114 are placed along the electrolyte 116 with thermocouples 110 and 112 being placed on the cathode area 118 of the SOFC.

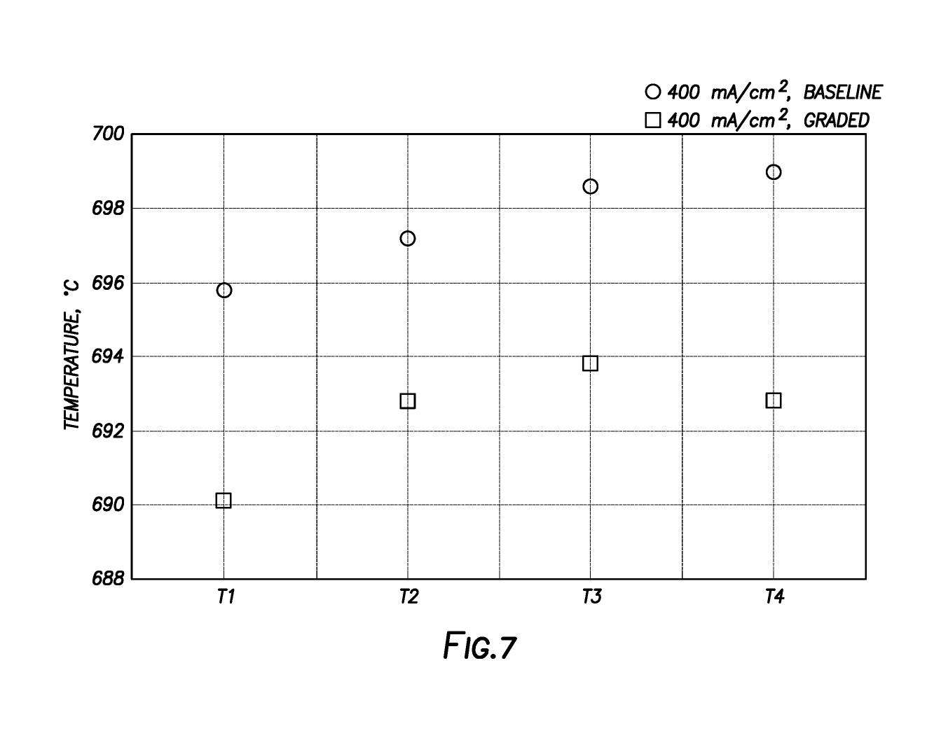

This variable thickness electrolyte was operated to generate a current density of 200 mA/cm² and 400 mA/cm². A baseline cell with uniform electrolyte thickness of 6 μm, and thermocouples placed in the same location, was operated to generate a current density of 200 mA/cm² and 400 mA/cm² as well. FIG. 6 depicts a comparative temperature results obtained at operating the SOFC to output 200 mA/cm². FIG. 7 depicts a comparative temperature results obtained at operating the SOFC to output 400 mA/cm². As shown in both FIG. 6 and FIG. 7 the variable thickness electrolyte causes the SOFC to operate with a more uniform temperature distribution across the fuel cell surface. Reducing SOFC's temperature distribution is theorized to prolong the lifespan of the device and improve efficiency.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A solid oxide fuel cell comprising:
a variable thickness electrolyte layer in contact between an anode and a cathode; and
a fuel inlet and a fuel outlet,
wherein the variable thickness electrolyte layer is thinner closer to the fuel inlet and thicker closer to the fuel outlet.

2. The solid oxide fuel cell of claim 1, wherein the fuel is selected from the group consisting of natural gas, hydrogen, carbon monoxide, syngas, biogas, landfill gas, gasoline, diesel, and combinations thereof.

3. The solid oxide fuel cell of claim 1, wherein the variable thickness electrolyte layer is a yttria-stabilized zirconia, gadolinium doped ceria, or doped lanthanum gallate.

4. The solid oxide fuel cell of claim 1, wherein the anode is a mixture of a nickel oxide and an yttria-stabilized zirconia or a mixture of a nickel oxide and a gadolinium doped ceria.

5. The solid oxide fuel cell of claim 1, wherein the cathode is selected from the group consisting of: samarium strontium cobaltite, lanthanum strontium cobalt ferrite, gadolinium doped ceria and combinations thereof.

6. The solid oxide fuel cell of claim 1, wherein the cathode is a mixture of samarium strontium cobaltite and gadolinium doped ceria.

7. The solid oxide fuel cell of claim 1, wherein the cathode is a mixture of lanthanum strontium cobalt ferrite and gadolinium doped ceria.

8. The solid oxide fuel cell of claim 1, wherein the difference between the thickest area of the variable thickness electrolyte layer and the thinnest area of the variable thickness electrolyte layer is greater than about 50 μm.

9. The solid oxide fuel cell of claim 1, wherein the difference between the thickest area of the variable thickness electrolyte layer and the thinnest area of the variable thickness electrolyte layer is from about 1 μm to about 50 μm.

10. The solid oxide fuel cell of claim 1, wherein the difference between the thickest area of the variable thickness electrolyte layer and the thinnest area of the variable thickness electrolyte layer is from about 5 μm to about 10 μm.

11. The solid oxide fuel cell of claim 1, wherein the manufacture of the variable thickness electrolyte layer is applied via a spray process, wherein the thicker area of the variable thickness electrolyte layer has a greater number of spray passes than the thinner area of the variable thickness electrolyte layer.

12. The solid oxide fuel cell of claim 11, wherein the number of spray passes range from about 2 to about 50.

13. The solid oxide fuel cell of claim 1, wherein the solid oxide fuel cell is planar.

14. The solid oxide fuel cell of claim 1, wherein the solid oxide fuel cell is tubular.

15. A planar solid oxide fuel cell comprising:
a yttria-stabilized zirconia variable thickness electrolyte layer in contact between an anode, comprising nickel oxide and yttria-stabilized zirconia, and a cathode, comprising lanthanum strontium cobalt ferrite and gadolinium doped ceria;
a fuel inlet and a fuel outlet,
wherein the yttria-stabilized zirconia variable thickness electrolyte layer in areas closer to the fuel inlet of natural gas is thinner than in areas closer to the fuel outlet of natural gas; and
wherein the difference between the thickest area of the yttria-stabilized zirconia variable thickness electrolyte layer and the thinnest area of the yttria-stabilized zirconia variable thickness electrolyte layer is greater than about 2.0 μm.
